(19) United States
(12) Patent Application Publication
(10) Pub. No.: US 2026/0057289 A1
(43) Pub. Date: Feb. 26, 2026

(54) MODEL PROCESSING METHOD FOR EDGE COMPUTING DEVICES AND A CLOUD SERVICE SYSTEM

(71) Applicant: Honeywell International Inc., Charlotte, NC (US)

(72) Inventors: Rod Stein, Edmonton (CA); Jai Sharma, Bangalore (IN); Radu Siminiceanu, Glen Allen, VA (US)

(21) Appl. No.: 18/811,764

(22) Filed: Aug. 22, 2024

(51) Int. Cl. G06N 20/00

(52) U.S. Cl. CPC G06N 20/00

(57) ABSTRACT

The present disclosure provides a model processing method for edge computing devices and a cloud service system thereof. The cloud service system comprising, a cloud server, and a plurality of edge devices, wherein at least one edge device in the plurality of edge devices is connected to the cloud server through a network, said at least one edge device further connected to a plurality of data collectors, wherein the at least one edge device is configured to obtain at least one contextual data set from the at least one of the plurality of data collectors, aggregate the at least one contextual data set obtained from the at least one of the plurality of data collectors, train at least one of the aggregated contextual data set to create a data model, and push the data model to the cloud server to update at least a portion of a cloud data model. The method for cloud service system is also disclosed.

### FIELD OF INVENTION

The present disclosure generally relates to the field of cloud computing systems, more particularly to localized model generation and cloud import. Particularly, the present disclosure provides a model processing method for edge computing devices and a cloud service system thereof.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Data management in business enterprise are typically complex. Typical business processes generate substantially great volumes of data that cannot be processed by the human in its raw form. For instance, it is not unheard of for an industrial plant to have hundreds of sensors and control components monitoring and/or managing various aspects of a multi-stage process. These sensors come in a variety of types and provide information on various process attributes. The significance of their measurements, the quantity of data sent for each measurement, and the frequency of their measures all differ in a comparable way in their outputs. In reference to the latter, certain sensors and/or control elements measure one or more times per second in order to ensure accuracy and facilitate prompt reaction. Multiplying a single sensor and/or control with thousands of sensors and/or controls (a typical industrial control environment) results in a huge amount of data flowing into the production information and process control system.

Data integration is therefore essential for overall industry coordination, as failure to access a holistic view of data often leads to incorrect decisions that can affect industry performance. The traditional information and communication technology (ICT) solution is to acquire advanced powerful systems for data storage, processing and analysis. Deploying on-premises solutions requires a massive overhead and a huge operational cost burden. Therefore, it is impractical to deploy on-site ICT infrastructure in all projects due to the large initial investment. Additionally, on-premises computing is static and typically more expensive to meet a sudden IT need.

Advanced data management and process visualization techniques have been developed to handle the large volumes of data produced by industrial systems. Industries increasingly depends upon highly automated data acquisition and control systems such as Internet of Things (IoT), artificial intelligence (AI), machine learning and cloud computing to ensure that processes are run efficiently, safely and reliably while lowering their overall production costs. These technologies facilitate real-time data processing, storage, and analysis, powering automation, predictive maintenance, and smart decision-making.

In this context, cloud computing is a key technology as it enables the storage and processing of large amounts of data in a cost-effective and scalable way. Industries migrated to cloud platforms in view of its innumerable benefits like scalability, on-demand, quick response to fluctuating demands, to reduce expenditures, to increase collaboration among stakeholders, security and compliance etc.

In a conventional setup, the data sets are sent to a cloud server by a terminal device and a model therein is updated based on the computed data and, the updated model is pushed down to all the terminal devices in the data path for future computing. Generally, an edge device performs edge computing using the model provided by the cloud server.

In order to improve the computing precision of the cloud service system, the terminal devices need to continuously send data sets to the cloud server to update the model provided by the cloud server. Due to this, computing amount of server is increased and its operating efficiency gets impacted. It means the computing happens twice, once at the server and once at the terminal device.

Further, conventional automated data collection and management systems rely heavily on cloud-based servers and databases, which can cause latency, slow, intermittent, and/or dropped connections.

Edge computing is a specific implementation of a cloud computing technology. Edge computing made distributed computing has a possibility to compute large volumes of data sets. The larger computing capabilities of the edge devices moved the model building outside of the data center to the decentralized environments. With the advent of computing abilities of the edge devices, processing of data can be done near to their source i.e. data collectors, data does not have be sent to remote cloud or other centralized processing systems.

Therefore, there is a need to update the model provided by the cloud server, taking into account of the larger computing abilities of the edge devices, without affecting the overall efficiency of the cloud service system.

### SUMMARY OF THE INVENTION

In general, embodiments of the present disclosure herein provide a solution in which an edge device create a data model to train the data sets received. Other implementations will be or will become, apparent to one with skill in the art upon examination of the following figures and detailed description. It is intended that all such additional implementations be included within this description be within the scope of the disclosure and be protected within the scope of the following claims.

In one embodiment, the present disclosure provides a cloud service system, including a cloud server, a plurality of edge devices and a plurality of data collectors. The plurality of edge devices is connected to the cloud server through a network and further connected to a plurality of data collectors. The system includes at least one edge device that is configured to obtain at least one contextual data set from at least one of the plurality of data collectors, wherein at least one contextual data set comprises sensor data representing operations of the at least one of the plurality of data collectors and wherein the at least one edge device of the plurality of edge devices is connected to the cloud server based on a user definition, aggregate the at least one contextual data set obtained from the at least one of the plurality of data collectors, train at least one of the aggregated data sets to create a data model and push the data model to the cloud server to update at least a portion of a cloud data model, wherein the cloud server is configured to receive the data model from the at least one of the edge devices periodically or based on automatic discovery. The system includes the cloud server that is configured to push at least the portion of the data model created by the at least one edge device to at least one of the plurality of other edge devices. The system includes at least one edge device that is further configured to send the data model to the at least one of the plurality of other edge devices along a data path. The system includes at least one edge device that is further configured to set up a new edge device or new data collector along the data path. The system includes at least one edge device that is further configured to store the at least one contextual data set obtained from the at least one of the plurality of data collectors. The system includes at least one edge device that is further configured to provide the data model to the cloud server in response to the one or more messages received from the cloud server, wherein the one or more messages comprises one or more query requests and a command. The system includes the cloud server that is further configured to receive and store the plurality of data models sent by the at least one of the plurality of edge devices, compare the received data models with cloud data model, update the cloud data model based on change in one or more attributes of received data models, determine the data model corresponding to at least one of the plurality of edge devices, and send the updated data model to the at least one of the plurality of edge devices.

In another embodiment, the present disclosure provides a method for cloud service system. The method includes obtaining by at least one edge device, at least one contextual data set from the at least one of the plurality of data collectors, wherein at least one contextual data set comprises sensor data representing operations of the at least one of the plurality of data collectors and wherein the at least one edge device of the plurality of edge devices is connected to the cloud server based on a user definition, aggregating at least one contextual data set obtained from the at least one of the plurality of data collectors, training at least one of the aggregated data sets to create a data model and pushing the data model to the cloud server to update at least a portion of a cloud data model. The method further comprises pushing at least the portion of the data model created by the at least one edge device, by the cloud server to the at least one of the plurality of other edge devices. The method further comprises sending the data model to the at least one of the plurality of other edge devices along a data path. Further, the method comprises setting up a new edge device or new data collector along the data path. Further, the method comprises providing the data model to the cloud server in response to receiving one or more messages from the cloud server, wherein the one or more messages comprises one or more query requests and a command. Further, the method comprises, receiving, by the cloud server, the data model from the at least one of the plurality of edge devices periodically or based on automatic discovery. Further, the method comprises receiving and storing by the cloud server the plurality of data models sent by at least one of the edge devices, comparing the received data models with cloud data model, updating the cloud data model based on change in the one or more attributes of received data models. Further, the method comprises determining the data model corresponding to the at least one of the edge devices by the cloud server and sending the updated data model to the at least one of the edge devices.

In yet another embodiment, the present disclosure provides a non-transitory computer readable medium storing program instructions for cloud service system. The program instructions, when executed, perform the steps of obtaining at least one contextual data set from the at least one of the plurality of data collectors, wherein at least one contextual data set comprises sensor data representing operations of at least one of the plurality of data collectors and wherein the at least one edge device of the plurality of edge devices is connected to the cloud server based on a user definition, aggregating at least one contextual data set obtained from the at least one of the plurality of data collectors, training at least one of the aggregated data sets to create a data model, and pushing the data model to the cloud server to update at least a portion of a cloud data model, wherein the cloud server is configured to receive the data model from the at least one of the plurality of edge devices periodically or based on automatic discovery. The program instructions, when executed, further perform the steps of pushing at least the portion of the data model, from the cloud server to the at least one of the plurality of edge devices. The program instructions, when executed, further perform the steps of sending the data model to at least one of the plurality of other edge devices along a data path. The program instructions, when executed, further perform the steps of setting up a new edge device or new data collector along the data path. The program instructions, when executed, further perform the steps of providing the data model to the cloud server in response to receiving one or more messages from the cloud server, wherein the one or more messages comprises one or more query requests and a command. The program instructions, when executed, further perform the steps of receiving and storing by the cloud server the plurality of data models sent by at least one of the plurality of edge devices, comparing the received data models with cloud data model, updating the cloud data model based on change in the attributes of received data models. The program instructions, when executed, further perform the steps of determining the data model corresponding to at least one of the plurality of edge devices by the cloud server and sending the updated data model to the at least one of the plurality of edge devices.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a schematic diagram of an application scenario of the present disclosure;

FIG. 2 illustrates a schematic diagram of a structure of a cloud service system;

FIG. 3 illustrates a schematic diagram of a structure of a cloud server system in accordance with the embodiments of the present disclosure;

FIG. 4 illustrates a system of model building in accordance with the embodiments of the present disclosure;

FIG. 5 illustrates a schematic flowchart of a model processing method for a cloud service system in accordance with the embodiments of the present disclosure;

FIG. 6 illustrates a schematic flow diagram of a model processing method for a cloud service system in accordance with the embodiments of the present disclosure;

FIG. 7 illustrates a schematic diagram of a cloud service system configured for model processing in accordance with the embodiments of the present disclosure;

FIG. 8 illustrates a schematic diagram of a cloud service system configured for model processing in accordance with the embodiments of the present disclosure;

FIG. 9 illustrates a schematic diagram of a structure of a computing apparatus in accordance with the embodiments of the present disclosure;

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations

In the present day, physical devices can exchange data with each other or control each other. The devices which can communicate with each other are classified as Internet of Things (IoT) devices. With shift to Industry 4.0, the IoT reached Industrial Sector. However, interoperability has been a central challenge, as networking together of previously isolated pieces of equipment is the basis of the Industrial Internet of Things (IIoT). The standardized communication methods and protocols such as OPC UA is indispensable to the deployment of IIoT. These standardized protocols will help to standardize the data from various equipments (for example transforming data from binary format to JSON publisher/subscriber format) and also allowing new equipments to be scaled more easily across the entire enterprise. The modern IoT edge device has computing abilities to run the standardized communication methods and protocols.

Embodiments of the invention herein generally describe non-conventional approaches to systems and methods for model processing and management that are not well-known, and further, are not taught or suggested by any known conventional methods or systems. The technological improvements include at least the operation and functioning of the computing system that are significant improvement over the conventional methods and systems. The embodiments of the disclosure described herein includes systems and methods to improve the overall efficiency and accuracy of the cloud computing system that previously existed. The description herein further describes some embodiments that enhances the operational efficiency and potential accuracy of the cloud server system by providing a localized model generation and cloud that effectively and more efficiently manages data sets from distributed assets for a user that is not anticipated by the prior art.

The present disclosure provides a model processing method for a cloud service system and a cloud service system, to resolve a technical problem about how to update a machine learning model in a cloud service system in a conventional technology, without affecting overall operating efficiency of a cloud service system. According to an embodiment, at least one of the plurality of edge devices connected to the cloud server performs trains at least one of the aggregated data sets and creates a data model. In an embodiment, data model may be pushed to the cloud server to update a portion of the data model therein. The updated portion of the data model may be then pushed to the at least one of the plurality of edge devices. The disclosed technique enhances the operational efficiency and potential accuracy of the cloud server system. A detailed explanation of a model processing method for a cloud service system and a cloud service system will be provided in the forthcoming paragraphs.

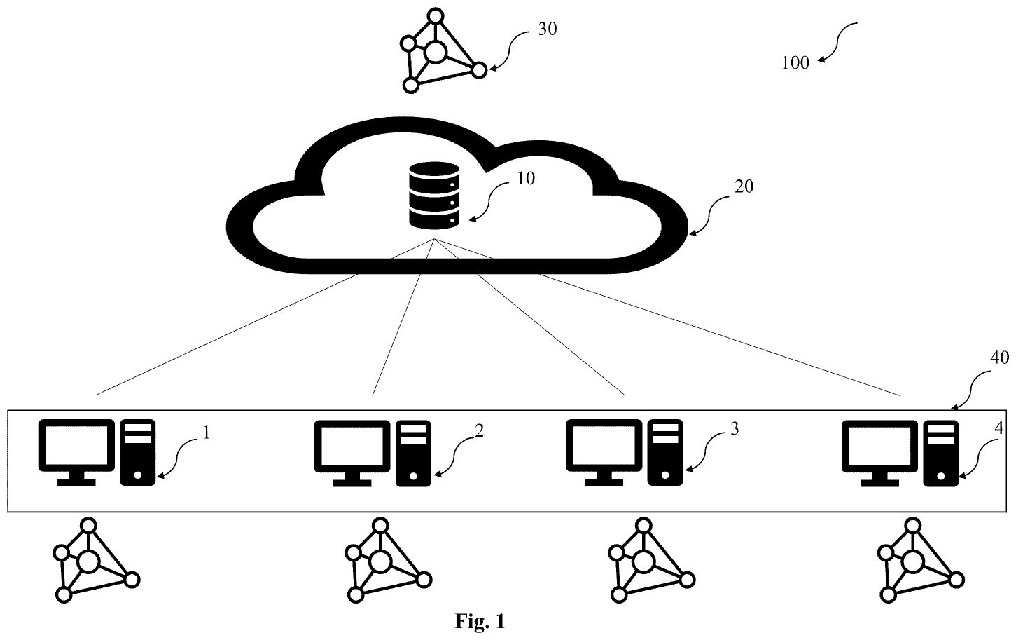

FIG. 1 illustrates an example of an application scenario of the present disclosure. Specifically, FIG. 1 depicts an environment 100 that includes one or more cloud servers 10 and one or more terminal devices 40 (1, 2, 3, 4) that may be operatively linked via one or more electronic communication links. For example, such electronic communication links may be established, at least in part, via a network 20 such as the Internet and/or other networks. The cloud server 10 provides cloud computing service, for example when a terminal device 40 used by a user requires some hardware and software computing resources and the cloud server 10 and terminal device 40 together may be referred to as “cloud service system”. The terminal device 40 may be edge device configured to implement edge computing. The terminal device 40 may perform edge computing to an object or data source in a cloud service system in real-time by bringing computing service as close as possible to devices that collects or generate data.

More specifically, the cloud server 10 obtains the machine learning model 30 by collecting large amount of training data and performs training by using a high-performance server. As shown in the FIG. 1, the cloud server may deliver the machine training model 30 to the four terminal devices numbered 1 to 4 and these devices in a cloud service system performs edge computing.

However, there may be a difference between the training data collected by the cloud server 10 and data set received from the data collectors by the terminal device 40 for edge computing. As a result, computing precision of edge computing performed by the machine learning model 30 may decrease. Hence, to improve the computing precision of the edge computing, the data set received by the terminal device 40 may be sent to the cloud server 10 to update the machine learning model therein and send the updated model 30 to each terminal device 40 for further computing. However, drawback of updating the model is that the computing capability of the cloud server 10 increases and also that modelling happens both at the server 10 and at the terminal device 40 over the same data set and thereby reduces the operating efficiency of the entire cloud service system.

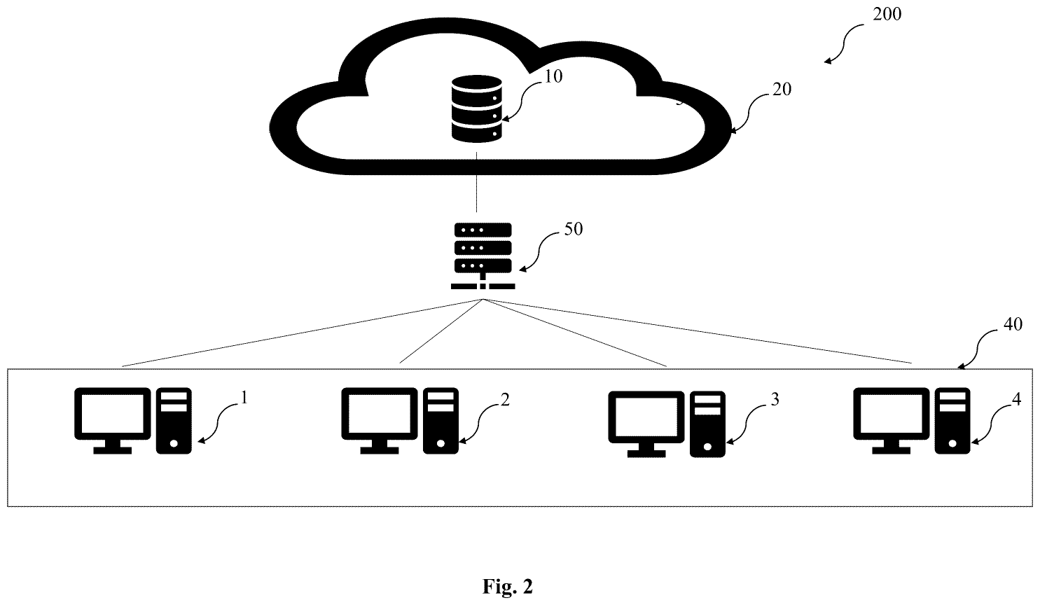

In another scenario of updating the machine learning model 30, FIG. 2 illustrates a schematic diagram of a structure of a cloud service system. The cloud service system shown in FIG. 2 includes a cloud server 10, one or more terminal device 40 (1, 2, 3, 4) and a plurality of local servers 50 that may be operatively linked via one or more electronic communication links. For example, such electronic communication links may be established, at least in part, via a network 20 such as the Internet and/or other networks. The plurality of local servers 50 in FIG. 2 are separately connected to the cloud server 3 and may further be connected to at least one edge device 40, and the edge device 40 may be a terminal device capable of performing edge computing. The local server 50 may be a server disposed at a place at which the plurality of edge devices are located.

In the scenario shown in the FIG. 2, after obtaining a plurality of machine learning models 30 by training, the cloud server 10 may send the plurality of machine learning models 30 to the connected local server 50, and the local server 50 sends the machine learning models 30 to the corresponding edge devices 40. In this process, the local server 50 may function as a gateway.

In the cloud service system shown in FIG. 2, the local server 50 and the cloud server 10 may further collaboratively update the machine learning models 30 provided by the cloud server 10 on the basis of implementing the edge computing. However, in this scenario, even though the amount of data exchange between the cloud server 10 and terminal device 40 may be reduced, usage of the local server 50 to update the machine learning model 30 may impact the operating efficiency of the entire cloud system. Further, in some scenarios, the local server 50 may receive and store the plurality of the models 30 sent by the cloud server 10 and may send the models 30 to corresponding edge devices 40 separately. In an example, the edge devices 40 which are not connected to the local server 50 may not obtain models 30 to perform the edge computing, thereby affecting the operating efficiency of the entire cloud service system.

Thus, the above two methods of updating the machine learning model 30 have respective disadvantages. When the cloud server 10 is relied on to perform updation or the local server 50 is employed to reduce the amount of the data exchange between the cloud server 10 and the edge device 40, system performance is reduced.

The present disclosure therefore provides a model processing method for a cloud service system and a cloud service system thereof. According to an embodiment of the present disclosure, a plurality of edge devices is disposed between a cloud server and a plurality of data collectors. At least one of the plurality of edge device obtains at least one contextual data set from at least one of the plurality of data collectors and performs edge computing and creates a data model. In this scenario, computing capabilities of the cloud server is reduced, and data exchange between the cloud server and the terminal device is reduced, thereby improving operating efficiency of the entire cloud service system.

Specific embodiments are used below to describe in detail the technical solutions of the present disclosure. The following several specific embodiments may be combined with each other, and a same or similar concept or process may not be described repeatedly in some embodiments.

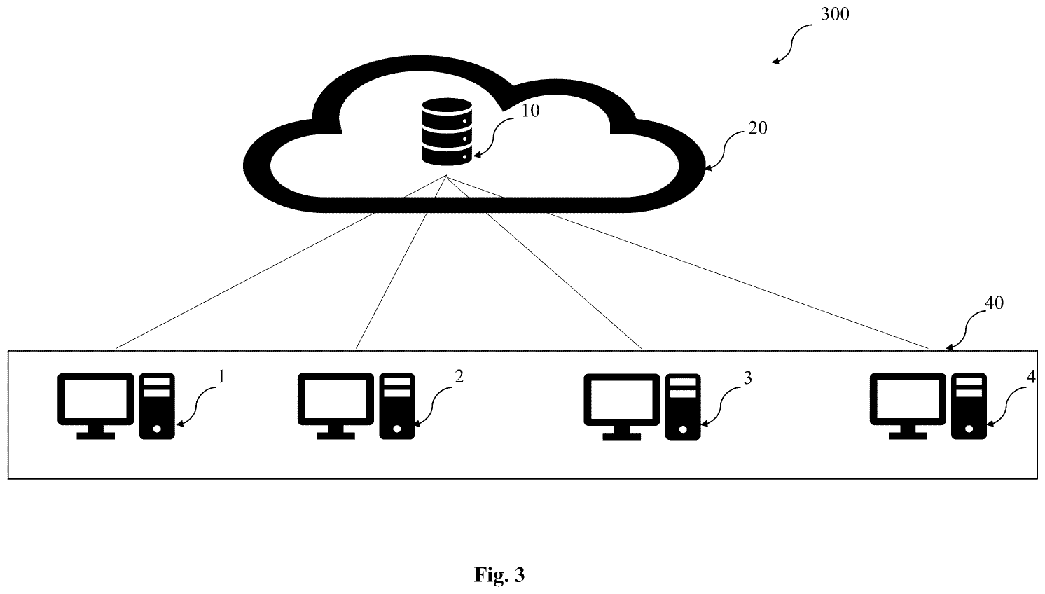

FIG. 3 illustrates a schematic diagram of a structure of a cloud server system in accordance with the embodiments of the present disclosure. The cloud service system shown in FIG. 3 includes a cloud server 10 and a plurality of the terminal devices 40 (1, 2, 3, 4) that may be operatively linked via one or more electronic communication links. For example, such electronic communication links may be established, at least in part, via a network 20 such as the Internet and/or other networks.

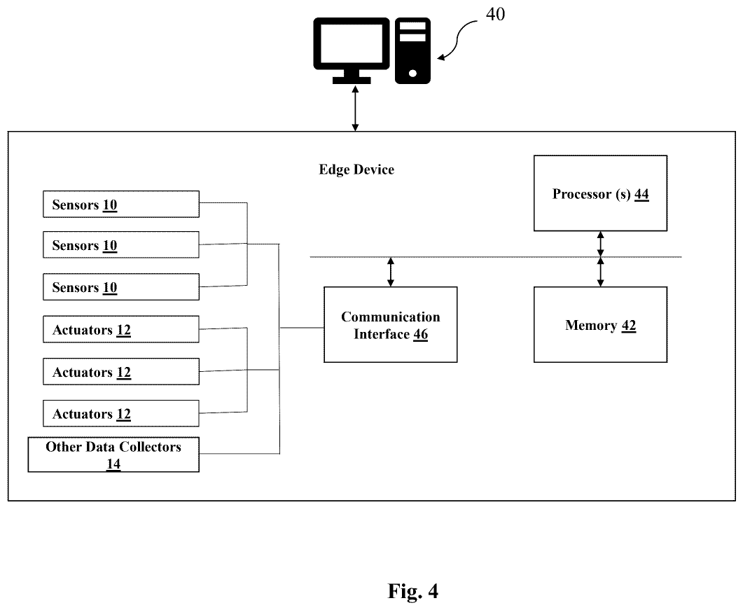

FIG. 4 illustrates a system of model building in accordance with the embodiments of the present disclosure. System shown in FIG. 4 may include a model building network that includes a plurality of edge devices 40. Edge device 40 may include one or more processors 44, one or more storage devices 42, communication interface 46 and/or other components. The edge device 40 through communication interface 46 may be operatively linked via one or more electronic communication links with one or more sensors 10, one or more actuators 12 and other data collectors 16. For example, such electronic communication links may be established, at least in part, via a network 20 such as the Internet and/or other networks.

In some embodiments, the other data collectors 16 may comprise a wide variety of sensors, actuators, machines, and other equipment. In some embodiments, the data collectors 16 may comprise pressure sensors, temperature sensors, motion sensors, density sensors, weight sensors, viscosity sensors, accelerometers, servos, and other kinds of sensors. In some embodiments, the data collectors 16 may comprise solenoids, motors, valves, heaters, heat exchangers, pumps, fans, boilers, turbines, generators, conveyors, augers, elevators, mills, drills, presses, and other manufacturing equipment. In some embodiments, the data collectors 16 may receive and/or transmit a variety of signals including analog signals and/or digital signals.

The sensors 12, actuators 14, and/or other data collectors 16 may generate data that is accessible locally to at least any one of the edge device 40. Such data may not be accessible to other edge devices 40 in the model building network.

Specifically, the edge device 40 may train large volume of data sets received from the plurality of data collectors to create a machine learning model 30. The edge device 40 may provide the model to the other edge devices 40 along the data path to perform edge computing. The edge device 40 may set up new edge device 40 or new data collector along the data path by using the obtained data model 30. The edge device 40 may aggregate the raw and contextual data set from the at least one data collector, and store the data set. The edge device 40 may receive one or more messages from the cloud server 10, and in response to the one or more messages, may provide the data model 30 to the cloud server 10.

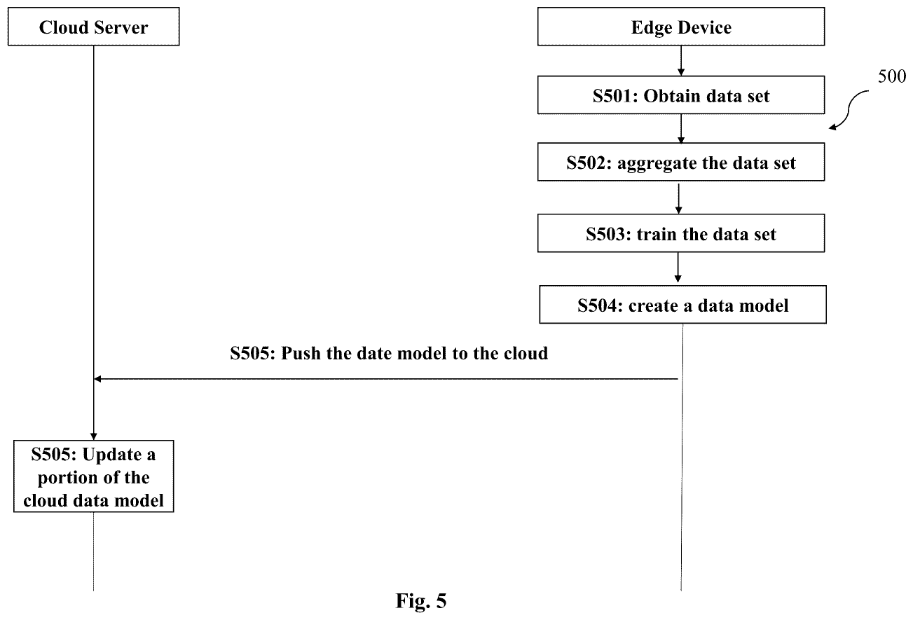

FIG. 5 illustrates a schematic flowchart of a model processing method for a cloud service system in accordance with the embodiments of the present disclosure. The method shown in FIG. 5 may be applied to the cloud service system shown in FIG. 3, the method is performed by the cloud server 10 and at least one edge device 40.

S501: The at least one of the plurality of edge devices obtains a contextual data set of the at least one of the plurality of data collectors. The data collectors may comprise a wide variety of sensors, actuators, machines, and other equipment. In some embodiments, the data collectors may comprise pressure sensors, temperature sensors, motion sensors, density sensors, weight sensors, viscosity sensors, accelerometers, servos, and other kinds of sensors. In some embodiments, the data collectors may comprise solenoids, motors, valves, heaters, heat exchangers, pumps, fans, boilers, turbines, generators, conveyors, augers, elevators, mills, drills, presses, and other manufacturing equipment. In some embodiments, the data collectors may receive and/or transmit a variety of signals including analog signals and/or digital signals.

Specifically, the model processing method provided in this embodiment is on the basis that the data collector has sent a contextual data set to the edge device, and the edge device has stored the contextual data set for use.

S502: The at least one of the plurality of the edge devices aggregate the at least one contextual data set obtained from the at least one of the plurality of data collectors.

S503: The at least one of the plurality of the edge devices train at least one of the aggregated data sets to create a data model.

S504: After creating a data model by performing edge computing on the contextual data set in S503, the at least one of the plurality of edge devices may send the obtained data model to the cloud server in S505, and correspondingly, the cloud server receives the data model sent by the at least one of the plurality of the edge devices. The cloud server may receive the data model from the at least one of the plurality of edge devices periodically or based on automatic discovery. The cloud server, after receiving the plurality of models from at least one of the plurality of edge devices, the cloud server stores the plurality of models in storage space of the cloud server.

The cloud server may include updating a portion of the cloud data model based on the data model provided by the at least one of the plurality of the edge devices. The updating of the cloud data model is user defined.

The cloud server may push at least the portion of the data model created by the at least one edge device to at least one of the plurality of other edge devices. The at least one of the plurality of edge devices may provide a data model to the cloud server or to at least one of the plurality of other edge devices in response to one or more messages received from the cloud server. The one or more messages received by the at least one of the plurality of edge devices may comprise one or more query request and a command. The cloud server and at least one of the plurality of other edge devices may receive data model from at least one of the edge device based on automatic discovery, periodically, user defined or any combination thereof.

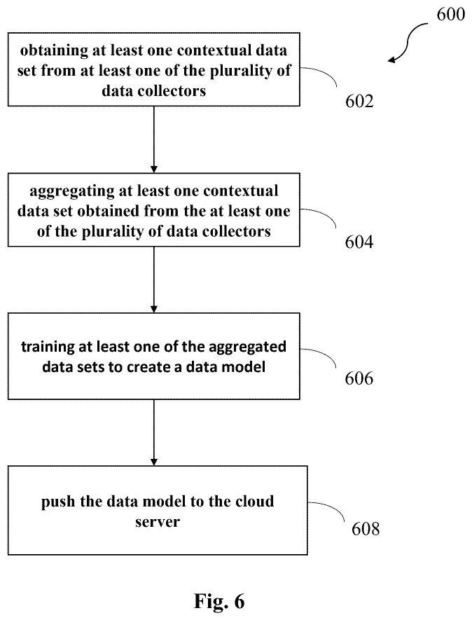

FIG. 6 illustrates a schematic flow diagram of a model processing method for a cloud service system in accordance with the embodiments of the present disclosure. Additionally, or alternatively, method 600 are directed to administration of a distributed edge computing system using a computing platform, according to various aspects of the disclosure. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method(s) 600 in response to instructions stored electronically on an electronic storage medium. The one or more processing devices may include one or more devices configured through hardware, firmware, and/or software to be specifically designed for execution of one or more of the operations of method 600.

FIG. 6 illustrates a model processing method for a cloud service system in accordance with the embodiments of the present disclosure using a computing platform, in accordance with one or more implementations.

Step 602 may include obtaining by at least one of the plurality of edge devices, at least one contextual data set from the at least one of the plurality of data collectors. The contextual data set may comprise sensor data representing the operations of the at least one of the plurality of the data collectors. The data collectors may comprise a wide variety of sensors, actuators, machines, and other equipment. In some embodiments, the data collectors may comprise pressure sensors, temperature sensors, motion sensors, density sensors, weight sensors, viscosity sensors, accelerometers, servos, and other kinds of sensors. In some embodiments, the data collectors may comprise solenoids, motors, valves, heaters, heat exchangers, pumps, fans, boilers, turbines, generators, conveyors, augers, elevators, mills, drills, presses, and other manufacturing equipment. In some embodiments, the data collectors may receive and/or transmit a variety of signals including analog signals and/or digital signals.

Step 604 may comprise aggregating the at least one contextual data set obtained from the at least one of the plurality of data collectors.

Step 606 may comprise training at least one of the aggregated data sets to create a data model. The at least one edge device of the plurality of edge devices is connected to the cloud server based on a user definition

Step 608 may comprise pushing the data model to the cloud server to update at least a portion of a cloud data model from at least one of the plurality of edge devices.

The cloud server may push at least the portion of the data model created by the at least one edge device to at least one of the plurality of other edge devices. The at least one of the plurality of edge devices may push the data model to at least one of the plurality of other edge devices along a data path. The at least one of the plurality of edge devices may provide a data model to the cloud server or to at least one of the plurality of other edge devices in response to one or more messages received from the cloud server. The one or more messages received by the at least one of the plurality of edge devices may comprise one or more query request and a command. The cloud server and at least one of the plurality of other edge devices may receive data model from at least one of the plurality of edge devices based on automatic discovery, periodically, user defined or any combination thereof. The cloud server after receiving the plurality of models from at least one of the plurality of edge devices, the cloud server stores the plurality of models in storage space of the cloud server. The cloud server may update a portion of the cloud data model based on the data model provided by the at least one of the plurality of the edge devices. The updating of the cloud data model is user defined. The cloud server may send the updated portion of the cloud data model to at least one of the plurality of the edge devices.

In the foregoing embodiments, the cloud service system and the model processing method for a cloud service system provided in embodiments of this application are described. To implement functions in the model processing method for a cloud service system provided in the foregoing embodiments of this disclosure, the cloud server and the edge device serving as performing systems each may include a hardware structure and/or a software module, and implement the foregoing functions in a form of a hardware structure, a software module, or a combination of a hardware structure and a software module. Whether one of the foregoing functions is performed by a hardware structure, a software module, or a hardware structure and a software module depends on a specific application and design constraints of the technical solutions.

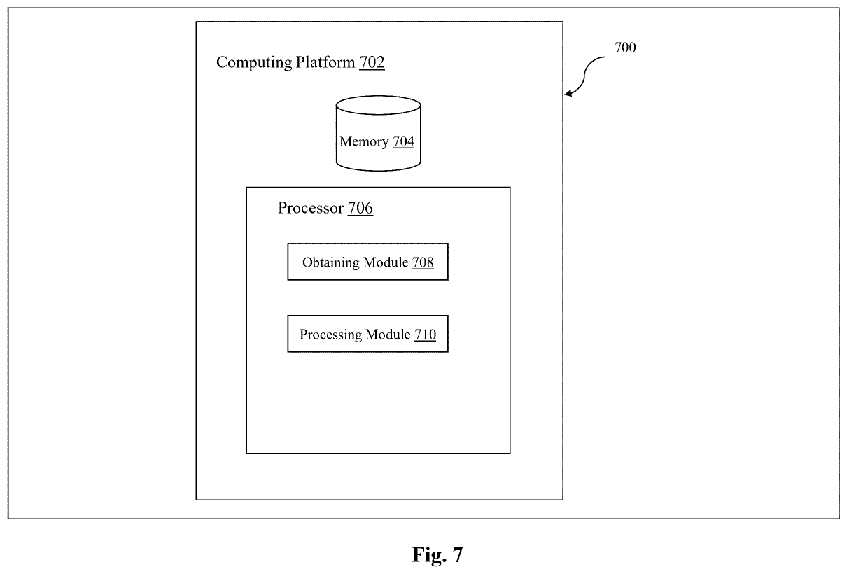

FIG. 7 illustrates a schematic diagram of a cloud service system configured for model processing in accordance with the embodiments of the present disclosure. The apparatus shown in FIG. 7 may be used as the at least one of the plurality of edge devices in the foregoing embodiments of the present disclosure, and perform the method performed by the at least one of the plurality of edge devices. In some implementations, system 700 may include one or more computing platforms 702. Computing platform(s) 702 may be configured by memory 704 in communication with the processor 706. The Processor 706 may include an obtaining module 708 and a processing module 710. The obtaining module 708 is configured to obtain by at least one of the plurality of edge devices at least one contextual data set from the at least one of the plurality of data collectors. The contextual data set may comprise sensor data representing the operations of the at least one of the plurality of data collectors. The processing module 710 is configured to aggregate at least one contextual data set obtained from the at least one of the plurality of data collectors and train at least one of the aggregated data sets to create a data model by the at least one of the plurality of edge devices on the received contextual data set. The at least one edge device of the plurality of edge devices is connected to the cloud server based on a user definition.

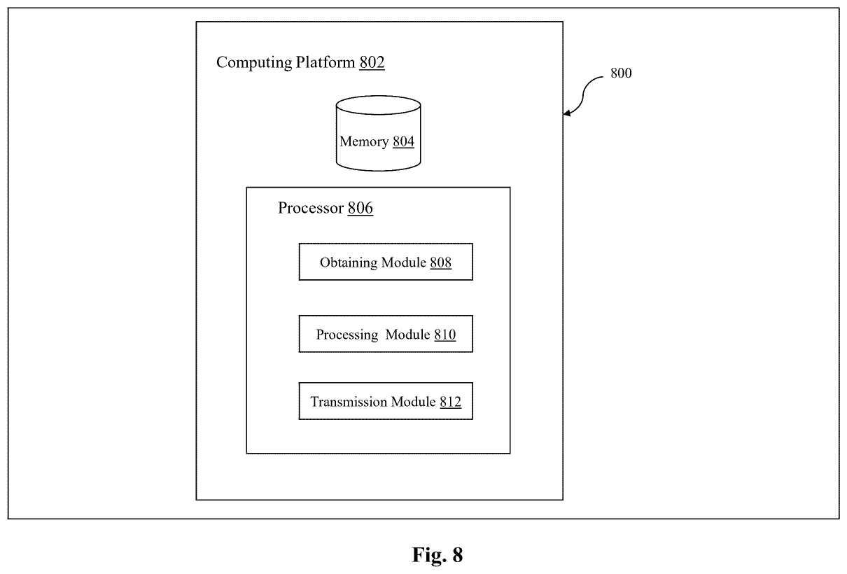

FIG. 8 illustrates a schematic diagram of a cloud service system configured for model processing in accordance with the embodiments of the present disclosure. The apparatus shown in FIG. 8 may be used by at least one of the plurality of edge devices and the cloud server in the foregoing embodiments of the present disclosure, and performs the method performed by the at least one of the plurality of edge devices and cloud server. In some implementations, system 800 may include one or more computing platforms 802. Computing platform(s) 802 may be configured by memory 804 in communication with the processor 806. The Processor 806 may include an obtaining module 808, a processing module 810 and a transmission module 812. The obtaining module 808 is configured to obtain by at least one of the plurality of edge devices at least one contextual data set from the at least one of the plurality of data collectors. The contextual data set may comprise sensor data representing the operations of the at least one of the plurality of the data collectors. The processing module 810 is configured to configured to aggregate at least one contextual data set obtained from the at least one of the plurality of data collectors and train at least one of the aggregated data sets to create a data model by the at least one of the plurality of edge devices on the received contextual data set. The at least one edge device of the plurality of edge devices is connected to the cloud server based on a user definition.

The transmission module 810 is configured to push the data model to the cloud server to update at least a portion of a cloud data model from at least one of the plurality of edge devices. The transmission module 810 is further configured to push the data model to at least one of the plurality of other edge devices along a data path.

Optionally, the transmission module 810 is further configured to provide the data model to the cloud server or to at least one of the plurality of other edge devices in response to one or more messages received from the cloud server.

Optionally, the transmission module 810 is further configured to provide the data model to the cloud server or to at least one of the plurality of other edge devices based on the request from the cloud server. The request may be automatic discovery carried out by the cloud server to receive the data model from the at least one of the plurality of edge devices. In some instances, the cloud server or at least one of the plurality of other edge devices may receive the data model from the at least one of the plurality of edge devices periodically which is user defined or automatically. In some instances, the cloud server or at least one of the plurality of other edge devices may receive the data model from the at least one of the plurality of edge devices, if the user using the cloud server system initiates a request. The cloud server or at least one of the plurality of other edge devices may receive the data model from the at least one of the plurality of edge devices, in the combination of above-mentioned instances.

Optionally, the obtaining module 808 is further configured to receive and store the plurality of data models sent by at least one of the plurality of edge devices.

Optionally, the processing module 810 is further configured to compare the received data models with cloud data model and update a portion of cloud data model based on change in the attributes of received data models. Optionally, the processing module 810 is further configured to determine the data model corresponding to at least one of the plurality of edge devices.

Optionally, the transmission module 810 is further configured to send the updated portion of the data model to the at least one of the plurality of edge devices.

It should be noted that, it should be understood that division of the modules of the foregoing apparatus is merely division of logical functions, and in actual implementation, all or some modules may be integrated into one physical entity, or may be physically separated. In addition, all of these modules may be implemented in a form of invoking software by a processor element, or all of these modules may be implemented in a form of hardware, or some modules are implemented in a form of invoking software by a processor element, and some modules are implemented in a form of hardware. For example, the processing module may be a separately disposed processor element, or may be integrated into a chip of the foregoing apparatus for implementation. In addition, the processing module may alternatively be stored in a memory of the foregoing apparatus in a form of program code, and a processor element of the foregoing apparatus invokes and executes a function of the foregoing determining module. Implementation of other modules is similar to that of the processing module. In addition, all or some of these modules may be integrated together, or may be implemented separately. The processor element described herein may be an integrated circuit and has a signal processing capability. In an implementation process, steps in the foregoing methods or the foregoing modules can be implemented by using a hardware integrated logical circuit in the processor element, or by using instructions in a form of software.

For example, the foregoing modules may be one or more integrated circuits configured to implement the foregoing method, for example, one or more application-specific integrated circuits (ASIC), or one or more microprocessors (DSP), or one or more field programmable gate arrays (FPGA), or the like. In another example, when one of the foregoing modules is implemented in a form of invoking program code by a processor element, the processor element may be a general-purpose processor, for example, a central processing unit (CPU) or another processor that can invoke the program code. For another example, the modules may be integrated together and implemented in a form of a system-on-a-chip (SOC).

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

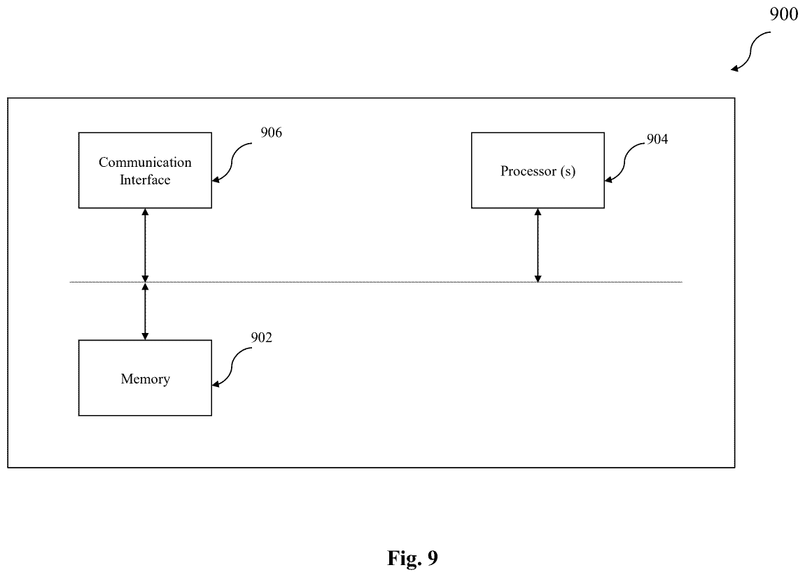

In addition, an embodiment of the present disclosure further provides another structure of a computing apparatus that can be used to implement an edge device or a cloud server provided in this present disclosure. FIG. 9 illustrates a schematic diagram of a structure of a computing apparatus in accordance with the embodiments of the present disclosure. The apparatus shown in FIG. 9 may be used as the edge device and cloud server in the foregoing embodiments of this present disclosure, and perform the method performed by the edge device and the cloud server. As shown in FIG. 9, the computing apparatus 900 may include a communications interface 906 and a processor 904. Optionally, the apparatus 900 may further include a memory 902. The memory 902 may be disposed inside the apparatus, or may be disposed outside the apparatus.

In an embodiment, the processor 904 coupled with the memory 902 is configured to obtain at least one contextual data set from the at least one of the plurality of data collectors, aggregate at least one contextual data set obtained from the at least one of the plurality of data collectors and train at least one of the aggregated data sets to create a data model. The processor 904 coupled with the memory 902 is further configured to push the data model to the cloud server to update at least a portion of a cloud data model. The processor 904 coupled with the memory 902 is further configured to send the data model to at least one of the plurality of other edge devices along a data path. The processor 904 coupled with the memory 902 is further configured to set up a new edge device or new data collector along the data path. The processor 904 coupled with the memory 902 is further configured to provide the data model to the cloud server in response to the one or more messages received from the cloud server, wherein the one or more messages comprises one or more query requests and a command. The processor 904 coupled with the memory 902 is further configured to receive and store the plurality of data models sent by at least one of the plurality of edge devices, compare the received data models with cloud data model, update a portion of the cloud data model based on change in the attributes of received data models, determine the data model corresponding to at least one of the plurality of edge devices, and send the updated portion of the data model to the at least one of the plurality of edge devices.

For example, actions performed by the edge device in FIG. 3 to FIG. 6B may all be implemented by the processor 904. The processor 904 receives data by using the communications interface 906, and is configured to implement any method performed by the edge device in FIG. 3 to FIG. 6B. In an implementation process, each step of the processing procedure may be implemented by using an integrated logical circuit of hardware in the processor 902 or an instruction in a form of software, to implement the method performed by the edge device in FIG. 3 to FIG. 6B. Program code executed by the processor 902 to implement the foregoing method may be stored in the memory 904.

In another example, actions performed by the cloud server in FIG. 3 to FIG. 6B may all be implemented by the processor 902. The processor 902 sends a control signal and communication data by using the communications interface 906, and is configured to implement any method performed by the cloud server in FIG. 3 to FIG. 6B. In an implementation process, each step of the processing procedure may be implemented by using an integrated logical circuit of hardware in the processor 902 or an instruction in a form of software, to implement the method performed by the cloud server in FIG. 3 to FIG. 6B. Program code executed by the processor 902 to implement the foregoing method may be stored in the memory 904.

Some features in this embodiment of this present disclosure may be implemented/supported by the processor 902 by executing program instructions or software code in the memory 904. Software components loaded on the memory 904 may be summarized from a functional or logical perspective, for example, the obtaining module 708 and the processing module 710 shown in FIG. 7; and in another example, the obtaining module 806, the processing module 808 and the transmission module 812 shown in FIG. 8.

Any communications interface in this embodiment of this present disclosure may be a circuit, a bus, a transceiver, or any other apparatus that may be configured to perform information exchange, for example, the communications interface 906 in the computing apparatus 900. For example, another apparatus may be a device connected to the computing apparatus. For example, when the computing apparatus is an edge device, another apparatus may be a cloud server. When the computing apparatus is a cloud server, another apparatus may be an edge device.

In an example, the processor(s) 902 may be a single processing unit or a number of units, all of which could include multiple computing units. The processor(s) 902 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 902 is configured to fetch and execute computer-readable instructions and data stored in the memory 904.

The memory 904 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The disclosed system and method may thereby be used for localized model generation and cloud import. The present disclosure provides a model processing method for a cloud service system and a cloud service system thereof. The embodiments of the present disclosure enable reducing the computing capabilities of the cloud server and reducing data exchange between the cloud server and the terminal device, thereby improving operating efficiency of the entire cloud service system.

The disclosed embodiments enhance the operational efficiency and potential accuracy of the cloud server system by providing a model processing method for a cloud service system that effectively and more efficiently manages data sets from distributed assets for a user. In the present disclosure, as the processing of data is near their source i.e. sensors, actuators, etc., data does not have to be sent to cloud server or other centralized processing systems. This means the raw and contextual data is trained next to the data collectors where the context is known. Further, if the trained model is sent to the other edge devices in the data path, they would also have contextual data to work with. The present disclosure which enables modelling of data by the edge devices improves the accuracy of the cloud service system. Also, as the contextual data is less error prone, the method allows to have more automatic operations, and allows future processes to glean future knowledge out of the data collected and stored.

Further, as the data modelling happens at the device level, and if the new device or new data collector has to be configured along the data path, the user can configure the device or data collector as the user has more knowledge about the working environment. Once the new device is set up and data collection is configured for the device, the device will train the data and model may be pushed to the cloud.

The disclosed system and method have the following benefits—faster response times—i.e. data latency is reduced as the data is not sent to the cloud for processing, improves offline capability—as the data is processed on edge device there is no need for constant network connection with the cloud server, reduces cost as we are storing more data locally on edge devices.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

What is claimed:

1. A cloud service system, comprising:
a cloud server; and
a plurality of edge devices, wherein at least one edge device in the plurality of edge devices is connected to the cloud server through a network, said at least one edge device further connected to a plurality of data collectors;
wherein the at least one edge device is configured to:
obtain at least one contextual data set from the at least one of the plurality of data collectors;
aggregate the at least one contextual data set obtained from the at least one of the plurality of data collectors;
train at least one of the aggregated contextual data set to create a data model; and
push the data model to the cloud server to update at least a portion of a cloud data model.

2. The system of claim 1, wherein the cloud server is configured to push at least the portion of the data model created by the at least one edge device to at least one of a plurality of other edge devices.

3. The system of claim 2, wherein the at least one edge device is further configured to:
send the data model to the at least one of the plurality of other edge devices along a data path.

4. The system of claim 3, wherein the at least one edge device is further configured to:
set up a new edge device or a new data collector along the data path.

5. The system of claim 1, wherein the at least one contextual data set comprises sensor data representing operations of at least one of the plurality of data collectors.

6. The system of claim 1, wherein the at least one edge device is further configured to:
store the at least one contextual data set obtained from the at least one of the plurality of data collectors.

7. The system of claim 1, wherein the at least one edge device is further configured to:
receive one or more messages from the cloud server, wherein the one or more messages comprises one or more query requests and a command; and
in response to the one or more messages, provide the data model to the cloud server.

8. The system of claim 1, wherein the at least one edge device of the plurality of edge devices is connected to the cloud server based on a user definition.

9. The system of claim 1, wherein the cloud server is configured to receive the data model from the at least one edge device of the plurality of edge devices periodically or based on automatic discovery.

10. The system of claim 1, wherein the cloud server is further configured to:
receive and store a plurality of data models sent by the at least one edge device of the plurality of edge devices;
compare the plurality of data models with the cloud data model;
update the cloud data model based on change in one or more attributes of the plurality of data models;
determine the data model corresponding to at least one edge device of the plurality of edge devices; and
send the data model to the at least one edge device of the plurality of edge devices based on the determination.

11. A method for cloud service system, comprising:
obtaining at least one contextual data set from at least one of a plurality of data collectors connected to at least one edge device of a plurality of edge devices connected to a cloud sever through a network;
aggregating the at least one contextual data set obtained from the at least one of the plurality of data collectors;
training the at least one of the aggregated contextual data set to create a data model; and
pushing the data model to the cloud server to update at least a portion of a cloud data model.

12. The method of claim 11, further comprising pushing at least the portion of the data model created by the at least one edge device to the at least one of a plurality of other edge devices.

13. The method of claim 12, comprising sending the data model to the at least one of the plurality of other edge devices along a data path.

14. The method of claim 13, comprising setting up a new edge device or a new data collector along the data path.

15. The method of claim 11, wherein the at least one contextual data set comprises sensor data representing operations of the at least one of the plurality of data collectors.

16. The method of claim 11, comprising:
receiving one or more messages from the cloud server, wherein the one or more messages comprises one or more query requests and a command; and
in response to the one or more messages, providing the data model to the cloud server.

17. The method of claim 11, wherein the at least one edge device of the plurality of edge devices is connected to the cloud server based on a user definition.

18. The method of claim 11, further comprising receiving, by the cloud server, the data model from the at least one of the plurality of edge devices periodically or based on automatic discovery.

19. The method of claim 11, further comprising:
receiving and storing a plurality of data models sent by the at least one of the plurality of edge devices;
comparing the plurality of data models with the cloud data model;
updating the cloud data model based on change in one or more attributes of the plurality of data models;
determining the data model corresponding to the at least one of the plurality of edge devices; and
sending the data model to the at least one of the plurality of edge devices based on the determination.

20. A non-transitory computer readable medium storing program instructions for cloud service system, the program instructions when executed, perform the steps of:
obtaining at least one contextual data set from at least one of a plurality of data collectors connected to at least one edge device of a plurality of edge devices connected to a cloud sever through a network;
aggregating the at least one contextual data set obtained from the at least one of the plurality of data collectors;
training the at least one of the aggregated contextual data set to create a data model; and
pushing the data model to the cloud server to update at least a portion of a cloud data model.
